(19) United States
(12) Patent Application Publication
(10) Pub. No.: US 2024/0321066 A1
(43) Pub. Date: Sep. 26, 2024

(54) SELF-SERVICE POINT-OF-SALE TERMINAL

(71) Applicant: Toshiba Tec Kabushiki Kaisha, Tokyo (JP)

(72) Inventor: Fumiya ONUMA, Mishima Shizuoka (JP)

(21) Appl. No.: 18/443,140

(22) Filed: Feb. 15, 2024

(30) Foreign Application Priority Data
Mar. 24, 2023 (JP) 2023-047667

(51) Int. Cl. G07G 1/00; G06V 40/20

(52) U.S. Cl. CPC G07G 1/0018; G06V 40/20

(57) ABSTRACT

According to an embodiment, a self-service point-of-sale terminal includes a control unit configured to register an item in a sales transaction, a first display unit facing a customer operating the terminal in the sales transaction, a second display unit facing the customer operating the terminal in the sales transaction, and a peripheral interface connected to the control unit. The peripheral interface is configured to receive video of the customer operating the terminal from a camera. The control unit is configured to cause the first display unit to display information about the registered item, and cause the second display unit to display at least a part of the video received by the peripheral interface.

### CROSS-REFERENCE TO RELATED APPLICATION

This application is based upon and claims the benefit of priority from Japanese Patent Application No. 2023-047667, filed Mar. 24, 2023, the entire contents of which are incorporated herein by reference.

### FIELD

Embodiments described herein relate generally to a self-service point-of-sale (POS) terminal and a method for a self-service POS terminal.

### BACKGROUND

Self-service POS devices and a semi-self-service POS devices are being used in stores such as a shopping markets, large-scale retail stores, and department stores. A self-service POS device is a device with which the customer performs both a merchandise registration operation and a payment operation. A semi-self-service POS device is generally in this context a device with which the customer performs a payment operation after a registration operation is completed. Such a device may be more particularly referred to as a semi-service POS payment device or a self-service payment device.

Because a customer himself or herself performs operations, there may be unauthorized or fraudulent operations by a customer. An unauthorized operation with the self-service POS device may be scanning a symbol attached to a merchandise item not being purchased or failure to scan a symbol of an item being purchased. An unauthorized operation may also or instead occur in performing a payment operation. An unauthorized operation with a semi-self-service POS payment device is an unauthorized operation or fraudulent operation in performing a payment operation.

In order to prevent unauthorized operations by a customer at either a self-service POS device or a semi-self-service POS payment device (hereinafter, for simplicity, these are collectively referred to as a “self-service POS terminal”), a camera may be attached to the self-service POS terminal to pick up images of operations by a customer. The picked-up image or video can be transmitted to an attendant terminal that is used for monitoring the self-service POS terminal. A staff member (attendant) at the store checks the images or video displayed on the attendant terminal and thus checks whether there is an unauthorized operation by a customer or not, and takes measures if there is an unauthorized operation.

However, if the attending staff is limited for reasons such as a shortage of staff, sufficient checks and measures may not be achieved. Therefore, it may be necessary to prevent an unauthorized action by a customer by other mechanisms.

### BRIEF DESCRIPTION OF THE DRAWINGS

FIG. 1 shows a system according to a first embodiment.

FIG. 2 is a perspective view of a self-service POS terminal.

FIG. 3 is a block diagram showing a hardware configuration of a self-service POS terminal.

FIG. 4 depicts a memory configuration of an unauthorized operation unit.

FIG. 5 is a block diagram showing a hardware configuration of an attendant terminal.

FIG. 6 is a block diagram depicting certain functional aspects of a self-service POS terminal.

FIG. 7 is a flowchart of control processing of a self-service POS terminal.

FIG. 8 is a flowchart of unauthorized action detection processing at a self-service POS terminal.

FIG. 9 shows an example of a displayed screen on a second display unit of a self-service POS terminal.

FIG. 10 shows an example of another displayed screen on a second display unit.

FIG. 11 is a flowchart of control processing of an attendant terminal.

FIG. 12 is a block diagram of a self-service POS terminal according to a second embodiment.

FIG. 13 is a flowchart of control processing of a self-service POS terminal of a second embodiment.

FIG. 14 is a flowchart of unauthorized action detection processing at a self-service POS terminal of a second embodiment.

FIG. 15 shows an example of a displayed screen on a second display unit of a self-service POS terminal of a second embodiment.

FIG. 16 is a flowchart of control processing of an attendant terminal.

### DETAILED DESCRIPTION

Example embodiments described herein provide a self-service POS terminal and a method therefor that improve existing technologies related to the prevention of unauthorized actions by a customer at a self-service POS terminal and the like.

In general, according to one embodiment, a self-service point-of-sale terminal includes a control unit configured to register an item in a sales transaction, a first display unit facing a customer operating the terminal in the sales transaction, a second display unit facing the customer operating the terminal in the sales transaction, and a peripheral interface connected to the control unit. The peripheral interface is configured to receive video of the customer operating the terminal from a camera. The control unit is configured to cause the first display unit to display information about the registered item, and cause the second display unit to display at least a part of the video received by the peripheral interface.

### First Embodiment

A first embodiment will now be described with reference to the drawings. In the first embodiment, a self-service POS device at which a customer can perform both a registration operation and a payment operation is described as an example.

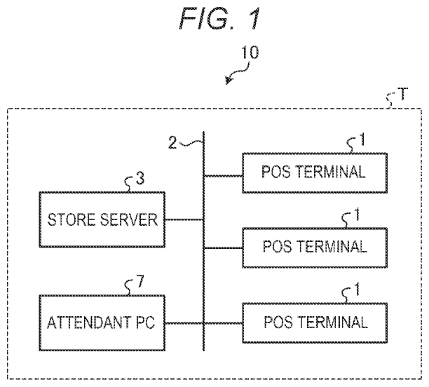

FIG. 1 shows a system according to the first embodiment. A system 10 is installed at a store T such as a supermarket, a large-scale retail store, a convenience store, or a specialty store. The system 10 performs merchandise registration processing, payment processing, sales management (tracking), and unauthorized action management (tracking) for merchandise items put on sale at the store T.

The system 10 includes at least one self-service POS terminal 1, a store server 3, and an attendant PC 7 (attendant terminal). The self-service POS terminal 1, the store server 3, and the attendant PC 7 are connected to each other, for example, via a communication line 2 such as a LAN.

One or more self-service POS terminals 1 can be installed in a payment area (checkout area) in the store T. In the first embodiment, three self-service POS terminals 1 are installed. The self-service POS terminal 1 is a merchandise sales data processing device with which a customer himself or herself performs a merchandise registration operation and a payment operation. The self-service POS terminal 1 executes merchandise registration processing for merchandise items on sale at the store T, in response to a merchandise registration operation by the customer (for example, an operation of causing a barcode reader or product scanner to read a symbol such as a barcode attached to a merchandise item). The self-service POS terminal 1 also executes settlement processing for a payment operation by the customer.

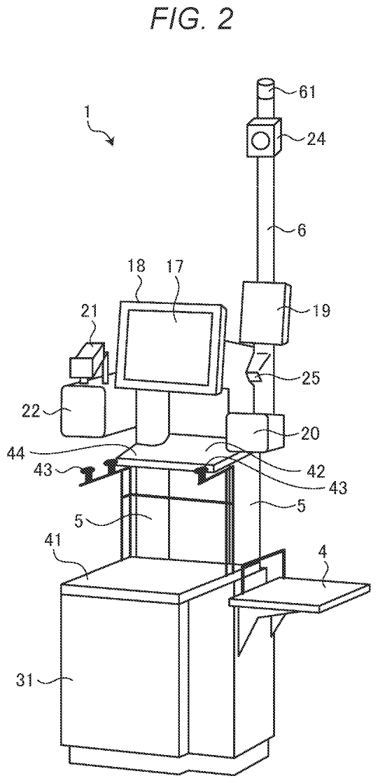

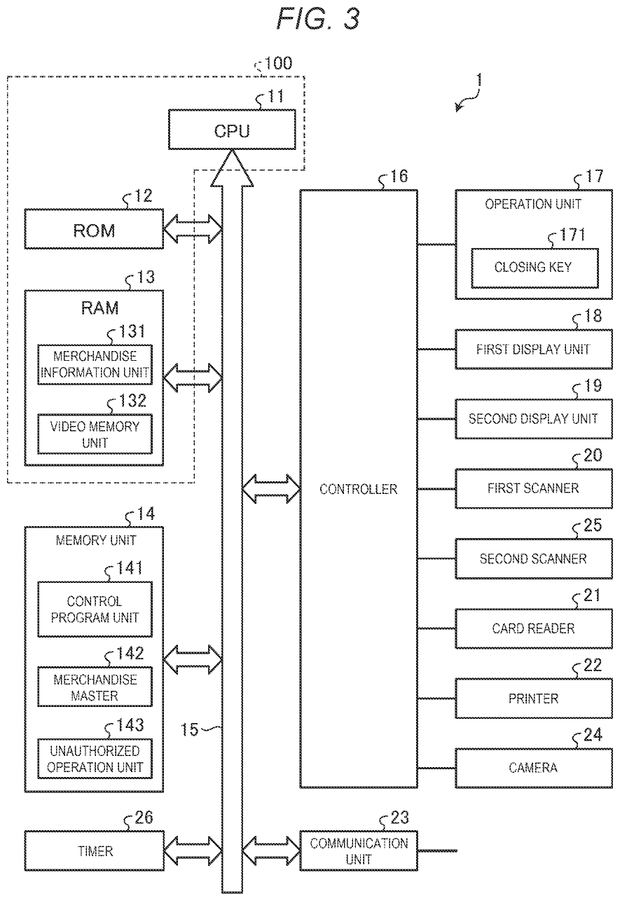

In this context, merchandise registration processing refers to processing for acquiring a merchandise code (merchandise specifying information), then displaying merchandise information related to merchandise code, such as the merchandise name and the price of the merchandise item on a first display unit 18 (see FIG. 2) and storing the merchandise information in a merchandise information unit 131 (see FIG. 3). In this context, settlement processing refers to the closing processing for the sales transaction including the merchandise information stored in the merchandise information unit 131 by the merchandise registration processing. Specifically, displaying a total amount due in the sales transaction on the first display unit 18, processing a settlement payment by a medium such as cash, credit card, or electronic money, as well as the processing of calculating an amount of change due based on the amount of a cash deposit and displaying the amount of change on the first display unit 18, then processing for dispensing a receipt on which the merchandise information and payment information (e.g., total transaction amount, amount of deposit/payment, amount of change, loyalty point information, and the like) is printed. A printer 22 (see FIG. 3), or the like may be used for dispensing the receipt.

The self-service POS terminal 1 also transmits the merchandise information and the payment information of a transaction (collectively referred to here as “sales data”) to the store server 3. In this first embodiment, the timing for transmitting the sales data from the self-service POS terminal 1 to the store server 3 is whenever the payment processing is finished. However, in other examples, the sales data may be transmitted at any other time. For example, the sales data for each day may be transmitted at the closing time of the store T, or the like.

The self-service POS terminal 1 acquires images of the customer operating the self-service POS terminal 1 including the merchandise registration operation and the payment operation by the customer using a camera 24 (see FIG. 2). In the present example, the images are video of the customer. The self-service POS terminal 1 displays the acquired video in real time on a second display unit 19 that displays information to the customer (e.g., a display unit facing customer). That is, the self-service POS terminal 1 displays all of the video of the operations of the self-service POS terminal 1 by the customer on the second display unit 19 as it occurs or is acquired.

The self-service POS terminal 1 also determines (detects) whether there is an unauthorized action in the operation of the self-service POS terminal 1 such as a merchandise misregistration operation or a payment maloperation by the customer or not, based on the video from the camera 24. If it is determined that there is an unauthorized action by the customer, the self-service POS terminal 1 displays a message on the second display unit 19 saying or indicating an unauthorized action has been detected.

The store server 3 is installed in a back office of the store T. The store server 3 gathers sales data received from the self-service POS terminal (s) 1. The store server 3 tracks the sales of merchandise at the store T, based on the gathered sales data.

The attendant PC 7 is, for example, a computer with a display unit, such as a personal computer, a tablet terminal, a PDA (personal digital assistant) or the like. The attendant PC 7 monitors the state of the self-service POS terminal 1 and the operation of the self-service POS terminal 1. The attendant PC 7 also receives the video from the camera 24 of each self-service POS terminal 1 and permits the operations by the customers to be monitored. In the first embodiment, the videos corresponding to the operations at the three self-service POS terminal 1 are displayed in divided areas on one display unit. The attendant (store clerk) monitors the videos displayed on the display unit.

If a self-service POS terminal 1 has determined that there is an unauthorized action by the customer, the attendant PC 7 displays a still image or the like showing the unauthorized action. The attendant then confirms whether there was an unauthorized action by the customer or not based on the displayed image.

If the attendant cannot determine whether there is an unauthorized action or not based on the displayed image, the attendant PC 7 then extracts a video clip covering a time bracket range around when the unauthorized action was likely to have been carried out. The attendant PC 7 displays the extracted video (the video clip) on the display unit of the attendant PC 7. The attendant then attempts to determine whether there was an unauthorized action based on the displayed video clip.

If the attendant has determined that there was an unauthorized action by the customer, the attendant goes to the corresponding self-service POS terminal 1 and checks with the customer.

The self-service POS terminal 1 will now be described. FIG. 2 is a perspective view showing the external appearance of a self-service POS terminal 1. As shown in FIG. 2, the self-service POS terminal 1 has a main body 31 and a basket placing table 4. The main body 31 houses therein circuits and components to control the self-service POS terminal 1 and a power supply. The basket placing table 4 is a table attached to one side of the main body 31 and is where a basket containing merchandise being purchased can be placed.

At the top of the main body 31, a planar merchandise placing section 41 is provided. The main body 31 has a pair of support posts 5 extending upward at a rear part of the merchandise placing section 41. The printer 22 for dispensing a receipt is attached to the support post 5. A card reader 21 that reads information from a card such as a credit card or a loyalty point card is attached to a top part of the printer 22.

A first scanner 20 and a second scanner 25 are attached to the support post 5 near the basket placing table 4. The first scanner 20 is installed with a reading surface facing the customer and reads a code symbol attached to a merchandise item. The second scanner 25 is attached above the first scanner 20. The second scanner 25 is installed with a reading surface facing obliquely downward of the first scanner 20 and also reads a code symbol attached to a merchandise item.

The first display unit 18 (display unit for customer) is provided at a position between the pair of support posts 5. The first display unit 18 is installed facing the customer performing the operations at the self-service POS terminal 1. The first display unit 18 is located slightly above the first scanner 20 and the printer 22 and at a height about equivalent to the card reader 21 and the second scanner 25.

The first display unit 18 displays merchandise information (merchandise name, merchandise price, and the like) of a merchandise item registered by merchandise registration processing and settlement information (total amount, amount of settlement, amount of change, and the like) of a merchandise item being purchased in settlement processing. At the display surface of the first display unit 18, an operation unit 17 formed of a touch panel is provided.

At a position below the first display unit 18, between the pair of support posts 5, a temporary placing table 44 where a merchandise item may be temporarily placed, and a pair of holder parts 43 to hold the handles of a shopping bag in which a registered merchandise item can be put, are provided. Any merchandise item put into a shopping bag held by the pair of holder parts 43 is also considered placed on the merchandise placing section 41.

A substantially cylindrical pole 6 extending upward is attached to the support post 5 on the side near the basket placing table 4. The second display unit 19, the camera 24, and a rotary beacon light 61 are attached to the pole 6.

The second display unit 19 is attached near the first display unit 18. The second display unit 19 is attached substantially directly above the first scanner 20 and the second scanner 25. The second display unit 19 is installed facing the customer performing the operations at the self-service POS terminal 1. The second display unit 19 displays information to the customer. The second display unit 19 displays the video from the camera 24 in real time. If the self-service POS terminal 1 determines that there is an unauthorized action by the customer, the second display unit 19 displays a message reporting the detection of the unauthorized action.

The camera 24 is attached at an upper part of the pole 6. The camera 24 picks up a video from above, thus the image range of camera 24 covers an area below the camera 24. The camera 24 picks up an image of the operation of the self-service POS terminal 1 by the customer. The camera 24 acquires images of the operations by the customer such as causing the first scanner 20 and the second scanner 25 to read a code symbol attached to a merchandise item, the customer putting a merchandise item into a shopping basket, the making of selections (user inputs) on operation unit 17 by the customer, and the like. The camera 24 acquires images of the operations by the customer from the start to the end of a transaction at the self-service POS terminal 1.

The rotary beacon light 61 turns on or flashes on and off if an abnormality occurs at the self-service POS terminal 1 (for example, the self-service POS terminal 1 has run out of the receipt paper) or if the customer calls the attendant.

At such a self-service POS terminal 1, the customer generally takes out a merchandise item from a basket placed on the basket placing table 4 and performs a merchandise registration operation of causing the first scanner 20 or the second scanner 25 to read a code symbol attached to the merchandise item. The customer then puts the merchandise item just read into a shopping bag held on the holder parts 43. The self-service POS terminal 1 executes merchandise registration processing on the scanned merchandise item. After performing the merchandise registration operation for all the merchandise items being purchased, the customer then performs a payment operation after pressing a payment button. The self-service POS terminal 1 executes settlement processing.

The self-service POS terminal 1 causes the camera 24 to acquire video of the transaction, and displays the video in real time on the second display unit 19. Video is acquired from the start of the merchandise registration operation until the end of the settlement processing. The video displayed on the second display unit 19 is displayed to the customer performing the operations. The self-service POS terminal 1 also transmits the video from the camera 24 to the attendant PC 7 in real time.

The self-service POS terminal 1 itself determines whether there has been an unauthorized action by the customer or not based on the video from the camera 24. In this context, an unauthorized action by the customer is a movement with one or more different features from the usual actions (in this context, a “usual action” is when the customer does not carry out an unauthorized action). Therefore, the self-service POS terminal 1 detects whether there is a movement with such a unusual feature in the video from the camera 24, and thus determines whether there is an unauthorized action by the customer or not on this basis. If it is determined that there was an unauthorized action by the customer, the self-service POS terminal 1 displays a message indicating that there was an unauthorized action on the second display unit 19.

If the second display unit 19 is not provided, the video from the camera 24 or a message indicating an unauthorized action may be displayed on the first display unit 18. However, this alternative arrangement may obstruct the display of the merchandise information and the settlement information. Therefore, in the first embodiment, the video from the camera 24 or a message indicating an unauthorized action is displayed on the second display unit 19. The second display unit 19 is a dedicated display unit for the display of video and messages to the customer and therefore enables the customer to view the video and the messages more easily.

FIG. 3 is a block diagram showing the hardware configuration of the self-service POS terminal 1. As shown in FIG. 3, the self-service POS terminal 1 has a CPU (central processing unit) 11, which is an example of a processor, a ROM (read-only memory) 12, a RAM (random-access memory) 13, a memory unit 14, and the like. The CPU 11 provides the overall control of the self-service POS terminal 1. The ROM 12 stores various programs. In the RAM 13, programs and various data are loaded. The memory unit 14 stores various programs. The CPU 11, the ROM 12, the RAM 13, and the memory unit 14 are coupled to each other via a bus 15. The CPU 11, the ROM 12, and the RAM 13 together form a control unit 100. That is, as the CPU 11 operates according to a control program stored in the ROM 12 or the memory unit 14 and loaded in the RAM 13, the control unit 100 executes control processing of the self-service POS terminal 1.

The RAM 13 has the merchandise information unit 131 and a video memory unit 132. The merchandise information unit 131 stores the merchandise information (merchandise code specifying a merchandise item, merchandise name, price, and the like) of a merchandise item registered by the merchandise registration processing. The video memory unit 132 stores the video from the camera 24. The video stored in the video memory unit 132 is a video including time information (e.g., timestamped).

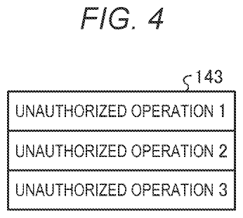

The memory unit 14 is formed of a non-volatile memory such as an HDD (hard disk drive) or a flash memory, which holds stored information even if the power is turned off. The memory unit 14 has a control program unit 141 storing a control program, a merchandise master 142, and an unauthorized operation unit 143. The merchandise master 142 stores the merchandise information of each merchandise item in correlation with the merchandise code specifying the merchandise item (merchandise specifying information). The unauthorized operation unit 143 stores information about an unauthorized operation of the self-service POS terminal 1. The unauthorized operation unit 143 will be described with reference to FIG. 4.

The control unit 100 is coupled to a timer 26 via the bus 15. The timer 26 tracks the current time.

The control unit 100 is also coupled to the operation unit 17, the first display unit 18, the second display unit 19, the first scanner 20, the second scanner 25, the card reader 21, the printer 22, and the camera 24 via the bus 15 and a peripheral controller 16 (also referred to as a controller, a peripheral interface, or peripheral connection interface).

The operation unit 17 has a closing key 171. The closing key 171 is a key to be operated when the self-service POS terminal 1 is to proceed from the merchandise registration processing to the settlement processing. The first display unit 18 is, for example, a liquid crystal display unit and displays information to the customer who is operating the self-service POS terminal 1. The first display unit 18 displays, for example, the merchandise information (merchandise name, merchandise price, and the like) of the merchandise item registered by the merchandise registration processing, and the payment information about the settlement processing, on a per merchandise item basis. The operation unit 17 is a touch panel provided on the first display unit 18. The second display unit 19 is, for example, a liquid crystal display unit and displays information to the customer operating the self-service POS terminal 1. The second display unit 19 displays video of the operations of the self-service POS terminal 1 by the customer and a message when there is an unauthorized action, or the like.

The first scanner 20 picks up an image of, or optically reads, a code symbol attached to a merchandise item. The second scanner 25 picks up an image of, or optically reads, a code symbol attached to a merchandise item. The second scanner 25 is provided above and near the first scanner 20. The first scanner 20 reads the code symbol into the direction of the customer. The second scanner 25 reads the code symbol obliquely downward from above. Therefore, the customer directs the code symbol in the direction of the first scanner 20 or the second scanner 25 and causes the code symbol to be scanned. The customer can thus cause at least one of these scanners to read the code symbol.

The card reader 21 reads card information from a card such as a credit card, a debit card, or an electronic money card, for example, when performing the settlement processing with the card. The card reader 21 also reads and writes point information from and to a loyalty point card. The printer 22 dispenses a receipt on which receipt information including the merchandise information and the settlement information is printed.

The camera 24 picks up an image of the operation of the self-service POS terminal 1 and provides a video. The camera 24 transmits the picked-up video to the peripheral controller 16.

The control unit 100 is coupled to a communication unit 23 via the bus 15. The communication unit 23 is communicably coupled to the store server 3 and the attendant PC 7 via the communication line 2. While the camera 24 is presently described as a component of the self-service POS terminal 1 in this first embodiment, in other examples, the camera 24 may be separate from the self-service POS terminal 1. If the camera 24 is not a component of the self-service POS terminal 1 (if the camera 24 is a separate device from the self-service POS terminal 1), the camera 24 may be coupled to the communication unit 23.

The unauthorized operation unit 143 will now be described. The unauthorized operation unit 143 stores an unauthorized action by the customer on a per unauthorized action type basis. The unauthorized action by the customer is, for example, an action of putting a merchandise item into a shopping bag without performing the merchandise registration operation, an action of performing the merchandise registration operation for an inexpensive merchandise item but then putting another merchandise item that has a similar shape but is more expensive into a shopping bag (for example, performing the merchandise registration operation for a bottle of inexpensive wine and putting a bottle of expensive wine into a shopping bag), an action of leaving without performing the payment operation, or the like. Each of these actions requires characteristic movements indicating the corresponding unauthorized action. The unauthorized operation unit 143 stores information representing the characteristic movements corresponding to each unauthorized action, on a per unauthorized action basis.

For example, information resulting from skeleton estimation of a characteristic movement corresponding to an unauthorized operation is stored for each unauthorized operation. By using a skeleton estimation technique (technique of estimating the position of the neck, shoulders, elbows, wrists, and the like of a person with high accuracy), which is a known technique, on the video, an unauthorized operation can be detected. In an example shown in FIG. 4, the unauthorized operation unit 143 stores information resulting from skeleton estimation of a characteristic movements corresponding to each of three different patterns (types) of unauthorized operation (an unauthorized operation 1, an unauthorized operation 2, and an unauthorized operation 3).

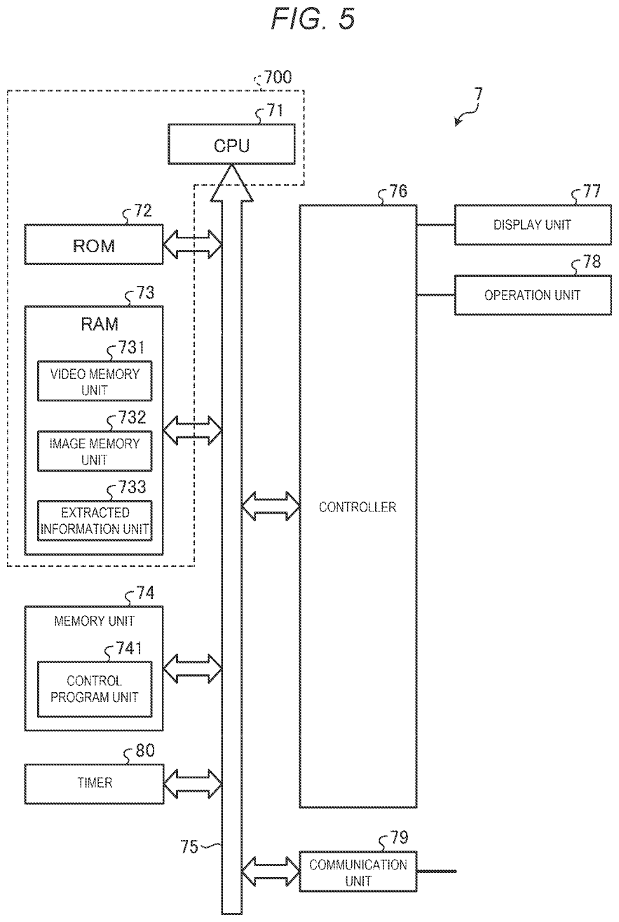

The hardware configuration of the attendant PC 7 will now be described. FIG. 5 is a block diagram showing the hardware configuration of the attendant PC 7. As shown in FIG. 5, the attendant PC 7 has a CPU 71, which is an example of a processor, a ROM 72, a RAM 73, a memory unit 74, and the like. The CPU 71 provides the overall control of the attendant PC 7. The ROM 72 stores various programs. In the RAM 73, programs and various data are loaded. The memory unit 74 stores various programs. The CPU 71, the ROM 72, the RAM 73, and the memory unit 74 are coupled to each other via a bus 75. The CPU 71, the ROM 72, and the RAM 73 together form a control unit 700. That is, as the CPU 71 operates according to a control program stored in the ROM 72 or the memory unit 74 and loaded in the RAM 73, the control unit 700 executes control processing of the attendant PC 7.

The RAM 73 has a video memory unit 731, an image memory unit 732, and an extracted information unit 733. The video memory unit 731 stores a video from the camera 24 as received from the self-service POS terminal 1. The image memory unit 732 stores a still image of the customer carrying out an unauthorized action as received from the self-service POS terminal 1. The extracted information unit 733 stores extracted information, which is a video clip extracted over a time bracket range whenever the customer carries out an unauthorized action. The video clip is generated from the video stored in the video memory unit 731.

The memory unit 74 is formed of a non-volatile memory such as an HDD or a flash memory, which holds stored information even if the power is turned off. The memory unit 74 has a control program unit 741. The control program unit 741 stores a control program to control the attendant PC 7.

The control unit 700 is coupled to a timer 80 via the bus 75. The timer 80 tracks the current time.

The control unit 700 is also coupled to a display unit 77 and an operation unit 78 via the bus 75 and a peripheral controller 76 (also referred to as a controller, a peripheral interface, or a peripheral connection interface). The display unit 77 is, for example, a liquid crystal display unit and displays information to the attendant who is the operator of the attendant PC 7. The operation unit 78 is a keyboard operated by the attendant.

The control unit 700 is coupled to a communication unit 79 via the bus 75. The communication unit 79 is communicably coupled to the store server 3 and the self-service POS terminal 1 via the communication line 2.

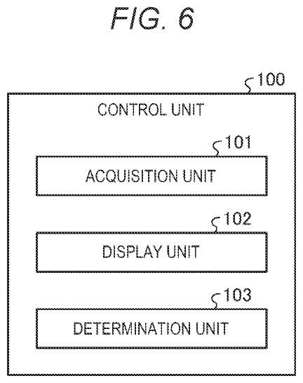

Certain functional aspects of a self-service POS terminal 1 according to the first embodiment will now be described. FIG. 6 is a block diagram showing functional aspects of the self-service POS terminal 1. The control unit 100 operates according to the control program stored in the ROM 12 or the control program unit 141 of the memory unit 14 and thus functions as an acquisition unit 101, a display unit 102, and a determination unit 103.

The acquisition unit 101 acquires a video of the operation of the self-service POS terminal 1 as picked up by the camera 24. Specifically, the acquisition unit 101 acquires a video of the operation of the self-service POS terminal 1 by the customer from the start to the end of a transaction at the self-service POS terminal 1.

The display unit 102 displays all or a part of the acquired video on the second display unit 19. In the first embodiment, the display unit 102 displays the video acquired by the acquisition unit 101 on the second display unit 19 as it is in real time.

The determination unit 103 detects whether there is an unauthorized action based on the acquired video. Specifically, the determination unit 103 determines whether there is an unauthorized action corresponding to the information representing an unauthorized action stored in the unauthorized operation unit 143 based on the video from the camera 24. More specifically, the determination unit 103 performs a skeleton estimation on the customer using the video from the camera 24, thus estimates the movement of the neck, shoulders, elbows, wrists, and the like of the customer with high accuracy, compares the estimated movement with the movements indicating unauthorized actions as stored in the unauthorized operation unit 143, and checks which if any stored characteristic movements the estimated movement is equivalent to. If it is determined that there is an action equivalent to one of the stored characteristic movements, the determination unit 103 identifies (detects) that there was an unauthorized action by the customer. If it is determined that the estimated movement is not equivalent to any of the stored characteristic movements, the determination unit 103 determines that there was no unauthorized action by the customer.

In an embodiment, in order to accurately determine whether there is an unauthorized action by the customer or not, the determination unit 103 performs the determination comprehensively, using skeleton estimation in conjunction with event data generated by operations or detected events at the self-service POS terminal 1. For example, whether an operation of taking out a merchandise item from a shopping basket is carried out or not may be determined based on the skeleton estimation and then scan data (event data) resulting from the reading of a code symbol by the scanning of a merchandise item may be detected/determined. Whether an operation of putting the merchandise item into a shopping bag is carried out or not is detected, may be based on skeleton estimation of customer movements in the video, but if scan data has not been generated/detected, the putting of the merchandise item into a shopping bag may be considered an unauthorized operation. Similarly, if the operation of putting an item in the shopping bag is detected soon after an acquisition of a commodity code (an item scanning) was detected, the operation may be considered normal (or authorized).

The determination unit 103 identifies, for example, whether the unauthorized action of putting a merchandise item into a shopping bag without performing the merchandise registration operation is carried out or not. The determination unit 103 also identifies, for example, whether the unauthorized action of performing the merchandise registration operation for an inexpensive merchandise item and putting another merchandise item that has a similar shape or weight but is expensive into a shopping bag (for example, the action of performing the merchandise registration operation for a bottle of inexpensive wine and putting a bottle of expensive wine of the same shape into a shopping bag) is carried out or not. The determination unit 103 also identifies, for example, whether the unauthorized action of leaving without performing the payment operation is carried out or not.

If the determination unit 103 determines that there was an unauthorized action by the customer, the display unit 102 displays a message indicating the unauthorized action on the second display unit 19.

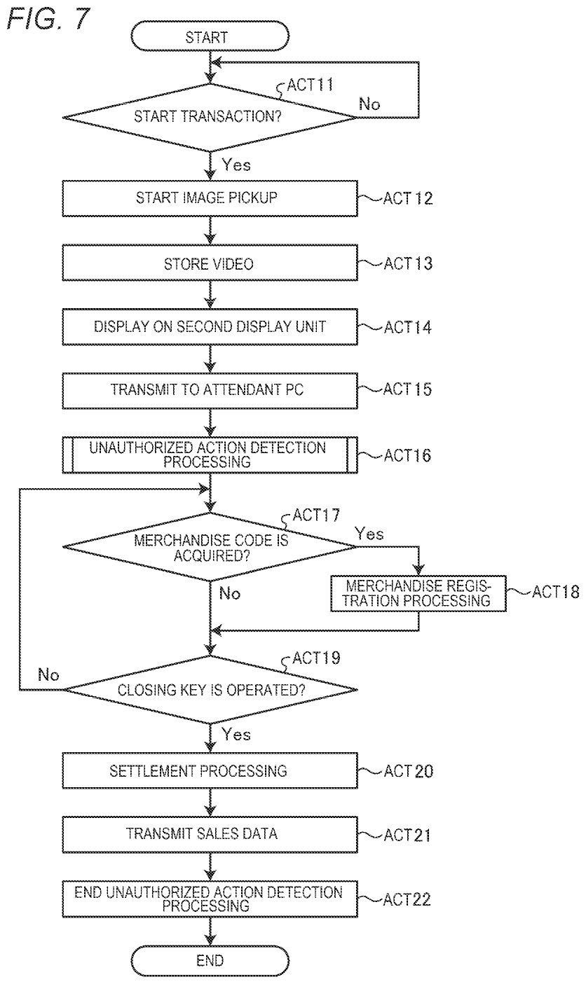

FIG. 7 is a flowchart showing a flow of the control processing of self-service POS terminal 1. As shown in FIG. 7, the control unit 100 of the self-service POS terminal 1 determines whether an operation to start a transaction is carried out by the customer at the self-service POS terminal 1 or not (ACT 11). For example, if a start button provided on the operation unit 17 is operated, the control unit 100 determines that an operation to start a transaction has been carried out by the customer. The control unit 100 waits until an operation to start a transaction is carried out (NO in ACT 11). If an operation to start a transaction is carried out (YES in ACT 11), the control unit 100 starts the image acquisition (pickup) of a video from the camera 24 (ACT 12).

Next, the acquisition unit 101 stores the video from the camera 24 (that is, acquires the video) (ACT 13). In ACT 13, the acquisition unit 101 stores the video from the camera 24 along with time information tracked by the timer 26 (time corresponding to when the video was acquired) in the video memory unit 132. That is, the video stored in the video memory unit 132 is information for which the time of the operation carried out by the customer is known. The time is stored along with the video picked up at predetermined intervals (for example, every 0.1 seconds).

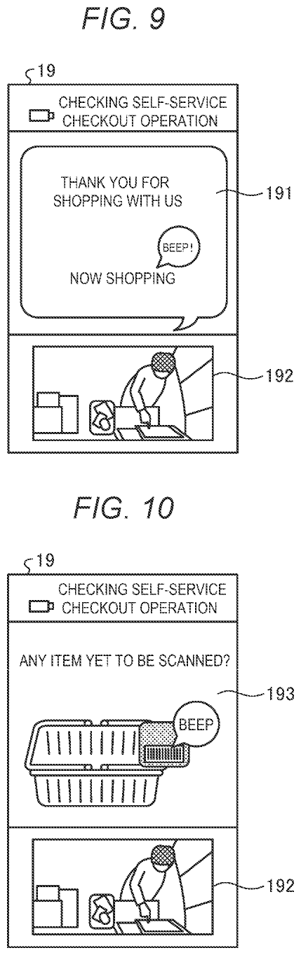

Next, the display unit 102 displays the video that was stored in the video memory unit 132 on the second display unit 19 in substantially real time (ACT 14). FIG. 9 shows a display example displayed on the second display unit 19 by the display unit 102 in the processing of ACT 14. As shown in FIG. 9, the display unit 102 displays a message 191 indicating that the customer is currently operating the self-service POS terminal 1, in an upper half area of the second display unit 19, and displays a video 192 stored in the video memory unit 132, in a lower half area of the second display unit 19. The video 192 is a real-time video from the camera 24. The display of the video 192 on the second display unit 19 continues until the transaction ends.

Referring back to FIG. 7, the control unit 100 transmits the video including the time information stored in the video memory unit 132 in ACT 13 to the attendant PC 7 (ACT 15). The processing of ACT 15 continues until the transaction ends.

Next, the control unit 100 starts a subroutine of unauthorized action detection processing (ACT 16). The unauthorized action detection processing is the processing of determining whether there is an unauthorized action by the customer in the operation of the self-service POS terminal 1 by the customer or not, and displaying a message indicating an unauthorized action on the second display unit 19 if it is determined that there is an unauthorized action. The started subroutine of unauthorized action detection processing is active until the transaction ends, so as to continue determining whether various unauthorized actions are carried out by the customer or not.

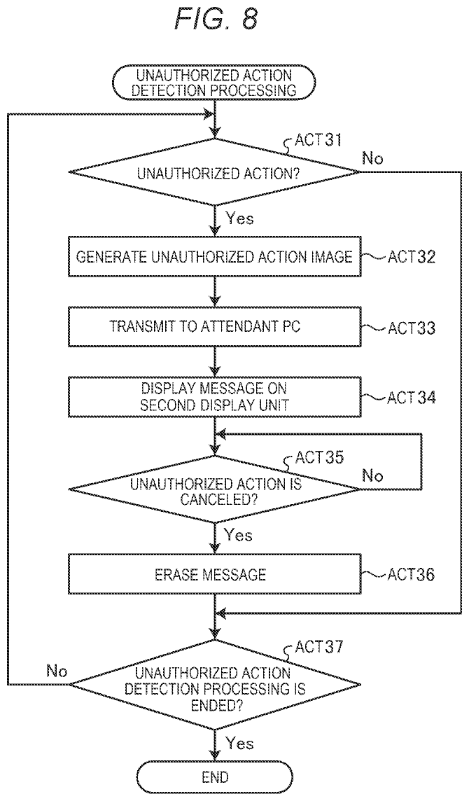

FIG. 8 shows the unauthorized action detection processing started in ACT 16. As shown in FIG. 8, the determination unit 103 determines whether there is an unauthorized action in the operation of the self-service POS terminal 1 by the customer or not (ACT 31). If it is determined that there is an unauthorized action (YES in ACT 31), the control unit 100 generates an unauthorized action image (still image) showing the unauthorized action (ACT 32). The control unit 100 extracts, for example, an image corresponding to the time when the determined unauthorized action is carried out, from the video stored in ACT 13, and thus generates an unauthorized action image.

Next, the control unit 100 transmits determination information that it is determined that there is an unauthorized action (including time information representing the time when the determined unauthorized action is carried out) and the generated unauthorized action image to the attendant PC 7 (ACT 33). Then, the display unit 102 displays a message indicating the unauthorized action on the second display unit 19 (ACT 34).

Next, the control unit 100 determines whether the unauthorized action is canceled or not (ACT 35). If the self-service POS terminal 1 determines that an unauthorized action is carried out by the customer, the attendant goes to this self-service POS terminal 1 and checks whether there is an unauthorized action or not. If an unauthorized action is carried out, the attendant corrects the unauthorized action. If it is confirmed that an unauthorized action is not carried out by the customer, the attendant corrects the determination about the unauthorized action. In such a case, the determination about the unauthorized action by the self-service POS terminal 1 is canceled by an operation by the attendant. The cancelation of the unauthorized action is carried out by an operation of the self-service POS terminal 1 or by an operation of the attendant PC.

The control unit 100 waits until the cancelation of the unauthorized action is carried out (NO in ACT 35). If it is determined that the cancelation of the unauthorized action is carried out (YES in ACT 35), the control unit 100 erases the message indicating the unauthorized action displayed on the second display unit 19 (ACT 36). Next, the control unit 100 determines whether the unauthorized action detection processing is ended or not (ACT 37). The end of the unauthorized action detection processing is carried out in the processing of ACT 22. If it is determined that the unauthorized action detection processing is not ended (NO in ACT 37), the control unit 100 returns to ACT 31 and continues monitoring whether there is an unauthorized action by the customer or not. If it is determined that the unauthorized action detection processing is ended (YES in ACT 37), the control unit 100 ends the processing of the subroutine started in ACT 16.

If it is determined in ACT 31 that there is no unauthorized action (NO in ACT 31), the control unit 100 executes the processing of ACT 37 without executing the processing of ACTS 32 to 36.

Referring back to FIG. 7, the control unit 100 then causes the first scanner 20 or the second scanner 25 to read a code symbol attached to a merchandise item and determines whether a merchandise code specifying this merchandise item is acquired or not (Act 17). When it is determined that the merchandise code is acquired (YES in ACT 17), the control unit 100 executes the merchandise registration processing for this merchandise item (ACT 18).

Next, the control unit 100 determines whether the closing key 171 is operated or not (that is, whether the payment operation is performed or not) (ACT 19). If it is determined that the closing key 171 is not operated (NO in ACT 19), the control unit 100 returns to ACT 17 and waits for the acquisition of the next merchandise code. If it is determined that the closing key 171 is operated (YES in ACT 19), the control unit 100 executes the settlement processing based on the merchandise information stored in the merchandise information unit 131 (ACT 20). The control unit 100 then transmits the merchandise information and the settlement information about the settled merchandise item to the store server 3 (ACT 21). The control unit 100 then ends the processing of the subroutine of unauthorized action detection processing started in ACT 16 and ends this transaction (ACT 22).

If it is determined in ACT 17 that the merchandise code is not acquired (NO in ACT 17), the control unit 100 executes the processing of ACT 19.

After the subroutine of unauthorized action detection processing is started in ACT 16, if an unauthorized action by the customer is detected during the processing of ACTS 17 to 22 (if YES is given in ACT 31), the control unit 100 makes an interruption at the timing when the unauthorized action is detected, so as to stop the processing of ACTS 17 to 22, and does not resume the processing until this unauthorized action is canceled (until YES is given in ACT 35).

Now, an example of a message indicating an unauthorized action displayed on the second display unit 19 in ACT 34 in the case where it is determined in ACT 31 that there is an unauthorized action because the customer puts a merchandise item into a shopping bag without causing the first scanner 20 or the second scanner 25 to read the code symbol attached to the merchandise item, will be described. FIG. 10 shows an example of the message displayed on the second display unit 19 of the self-service POS terminal 1. As shown in FIG. 10, a message 193 (prompting the customer to scan the merchandise item for which the unauthorized action was detected) is displayed on the second display unit 19 along with the real-time video 192 from the camera 24.

Displaying such a real-time video 192 on the second display unit 19 enables the prevention of an unauthorized action by the customer. Also, displaying the message 193 indicating that an unauthorized action is carried out, in the case where it is determined that there is an unauthorized action by the customer, along with the real-time video 192 on the second display unit 19, enables the enhancement of the deterrence against an unauthorized action by the customer.

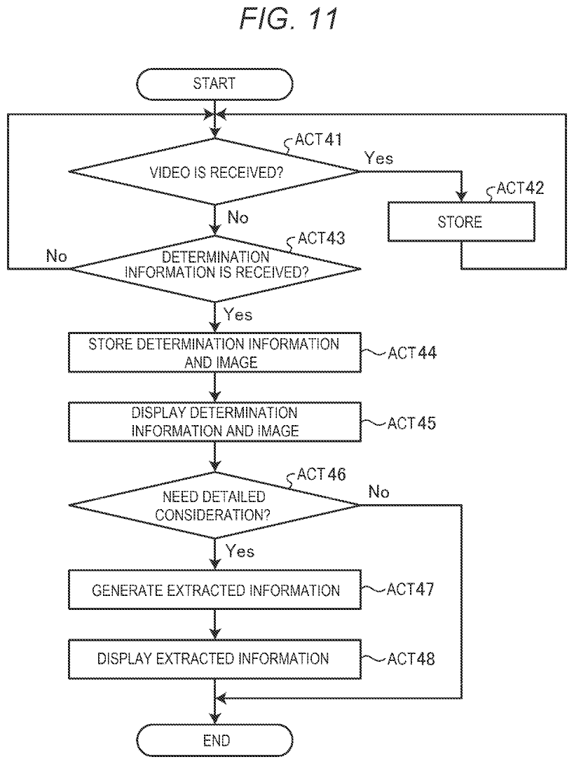

The control of the attendant PC 7 will now be described. FIG. 11 is a flowchart of the control processing of the attendant PC 7. As shown in FIG. 11, the control unit 700 of the attendant PC 7 determines whether a video including time information has been received from the self-service POS terminal 1 (ACT 41). If it is determined that a video including time information has been received (YES in ACT 41), the control unit 700 stores the received video (including the time information) in the video memory unit 731 (ACT 42). The control unit 700 then returns to ACT 41.

If it is determined that a video is not received (NO in ACT 41), the control unit 700 determines whether determination information that there has been an unauthorized action by the customer and a still image showing the unauthorized action have been received from the self-service POS terminal 1 (ACT 43). If the determination information and the still image showing the unauthorized action are not received (NO in ACT 43), the control unit 700 returns to ACT 41. If the determination information and the still image showing the unauthorized action are received (YES in ACT 43), the control unit 700 stores the determination information and the still image in the image memory unit 732 (ACT 44). The control unit 700 then displays, on the display unit 77, the information about the detection of an unauthorized action and the still image showing the unauthorized action (ACT 45).

The attendant now determines whether there is an unauthorized action or not based on the sent determination information and the image displayed on the display unit 77. If there is an unauthorized action by the customer, the attendant takes measures to cope with this unauthorized action. If there is not an unauthorized action by the customer or the determination is inconclusive, the attendant may need to make a more detailed consideration and therefore may decide to perform an operation for a more detailed consideration. The operation for a more detailed consideration refers to, for example, pressing a detailed consideration key provided on the operation unit 78.

Next, the control unit 700 determines whether the operation for a detailed consideration has been carried out or not (ACT 46). If yes (YES in ACT 46), the control unit 700 generates extracted information including a video clip extracted from the video stored in the video memory unit 731 covering a time bracket range around the time point when the unauthorized action was likely carried out (ACT 47). The control unit 700 then displays the generated extracted information on the display unit 77 (ACT 48). The attendant considers the customer behavior/operation in more detail and determines whether there is an unauthorized action by the customer or not, based on the extracted information (video clip) displayed on the display unit 77. The control unit 700 then ends the processing.

If the attendant determines a detailed consideration is not required to be carried out (NO in ACT 46), the control unit 700 ends the processing. The determination information, the image, and the extracted information displayed on the display unit 77 can be hidden or removed if the unauthorized action notification is canceled by the self-service POS terminal 1.

The self-service POS terminal 1 according to the first embodiment is a self-service POS terminal 1 at which the customer himself or herself carries out an operation has the second display unit 19, the acquisition unit 101 acquiring a video of the operation by the customer from the camera 24, and the display unit 102 displaying the acquired video on the second display unit 19 in real time.

In such a self-service POS terminal 1, the image of the operation by the customer at the self-service POS terminal 1 from the camera 24 is displayed on the second display unit 19 in real time. Therefore, an unauthorized action by the customer can be prevented or deterred.

### Second Embodiment

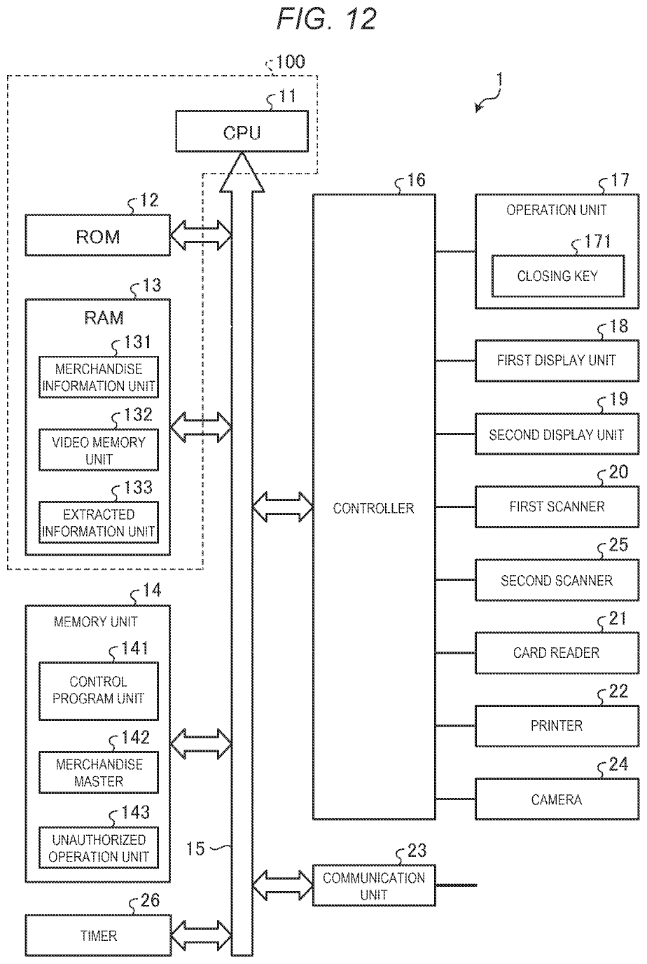

A second embodiment will now be described. While the self-service POS terminal 1 according to the first embodiment displays a video from the camera 24 on the second display unit 19 in real time, the self-service POS terminal 1 according to the second embodiment displays a video clip including an unauthorized action on the second display unit 19 only if the unauthorized action is detected as being carried out. In the second embodiment, components similar to those in the first embodiment are denoted by the same reference symbols as in the first embodiment and the description of these components may be omitted or simplified. FIG. 12 is a block diagram showing the hardware configuration of the self-service POS terminal 1 according to the second embodiment. As shown in FIG. 12, the RAM 13 of the self-service POS terminal 1 has an extracted information unit 133. If it is determined that an unauthorized action is carried out by the customer, the extracted information unit 133 stores extracted information including a video clip extracted from the video stored covering the time when the determined unauthorized action was carried out. The extracted information comprises video with time information similar to the extracted information stored in the extracted information unit 733 shown in FIG. 5. The other parts of the configuration are generally the same as in FIG. 5.

The functional aspects of the self-service POS terminal 1 according to the second embodiment will now be described. FIG. 6 also applies to the second embodiment. The control unit 100 of the self-service POS terminal 1 operates according to the control program stored in the ROM 12 or the control program unit 141 of the memory unit 14 and thus functions as the acquisition unit 101, the display unit 102, and the determination unit 103.

The acquisition unit 101 acquires a video of the operation of the self-service POS terminal 1 from the camera 24. Specifically, the acquisition unit 101 acquires a video of the operation of the self-service POS terminal 1 by the customer from the camera 24 from the start to the end of a transaction at the self-service POS terminal 1.

The display unit 102 displays a video clip extracted from the video acquired by the acquisition unit 101 on the second display unit 19.

The determination unit 103 determines whether there is an unauthorized action by the customer or not based on the acquired video. Specifically, the determination unit 103 determines whether an unauthorized action occurs in the video from the camera 24 by a correspondence to the information representing the unauthorized action (s) stored in the unauthorized operation unit 143. More specifically, the determination unit 103 performs a skeleton estimation of the customer in the video from the camera 24, thus estimates the movement of the neck, shoulders, elbows, wrists, and the like of the customer with high accuracy, compares the estimated movement with the information about movements indicating unauthorized actions stored in the unauthorized operation unit 143, and determines which if any movement matches the estimated movement. If it is determined that there is an action in the video that is equivalent to one of the movements of an unauthorized action, the determination unit 103 determines that there was an unauthorized action by the customer. If it is determined that the estimated movement does not match any of the stored movements, the determination unit 103 determines that there was no unauthorized action by the customer.

The determination unit 103 determines, for example, whether an unauthorized action of putting a merchandise item into a shopping bag without performing merchandise registration operation has been carried out or not. The determination unit 103 also determines, for example, whether an unauthorized action of performing a merchandise registration operation on an inexpensive merchandise item but putting another merchandise item with a similar shape or weight but that is more expensive into a shopping bag (for example, the action of performing the merchandise registration operation on a bottle of inexpensive wine and putting a bottle of expensive wine into a shopping bag) is carried out or not. The determination unit 103 also determines, for example, whether an unauthorized action of leaving without performing the payment operation has been carried out or not.

If the determination unit 103 determines that there is an unauthorized action by the customer, the display unit 102 extracts and displays a video clip including the time point when the unauthorized action is considered to have been carried out. The video clip is obtained from t the video acquired by the acquisition unit 101.

If the determination unit 103 identifies that there is an unauthorized action by the customer, the display unit 102 displays a message indicating the identified unauthorized action on the second display unit 19.

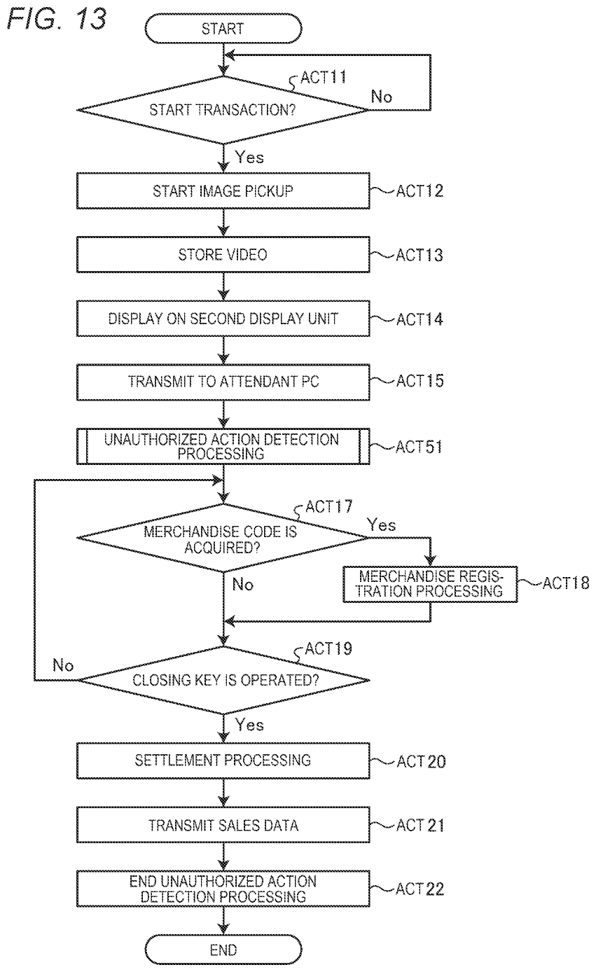

FIG. 13 is a flowchart of the control processing of the self-service POS terminal 1 according to the second embodiment. As shown in FIG. 13, unauthorized action detection processing of ACT 51 is executed instead of ACT 16 in FIG. 7. The other parts of the processing are executed similarly to those in FIG. 7 already described.

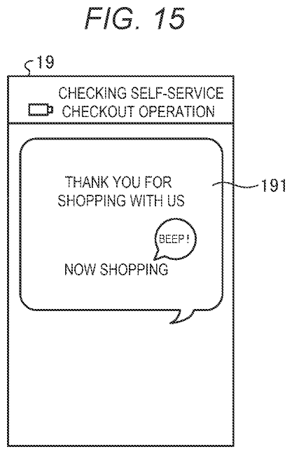

An example of the display on the second display unit 19 executed by the display unit 102 in ACT 14 in the second embodiment will now be described. FIG. 15 shows an example of the display on the second display unit 19 of the self-service POS terminal 1 in the second embodiment. As shown in FIG. 15, the display unit 102 displays the message 191 (indicating that the customer is currently operating the self-service POS terminal 1) in an upper half area of the second display unit 19, but does not display the video 192 on the second display unit 19 at this point.

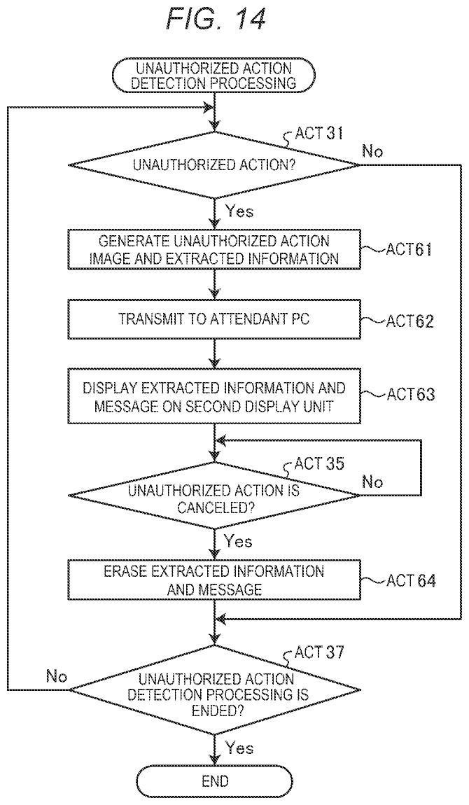

FIG. 14 shows the unauthorized action detection processing executed in ACT 51. As shown in FIG. 14, the determination unit 103 checks whether there is an unauthorized action in the operation of the self-service POS terminal 1 or not (ACT 31). If there is an unauthorized action (YES in ACT 31), the control unit 100 generates an unauthorized action image (a still image) along with extracted information indicating the unauthorized action (ACT 61). The control unit 100 extracts, for example, an image matching the time at which the unauthorized action was carried out. The image is extracted from the video stored in ACT 13, and may be referred to as an unauthorized action image. The control unit 100 may also generate a video clip extracted over a time bracket range around the detected unauthorized action (ACT 61).

Next, the control unit 100 transmits determination information for an unauthorized action (including time information representing the time when the determined unauthorized action was carried out) along with the generated unauthorized action image and other extracted information to the attendant PC 7 (ACT 62). Then, the display unit 102 displays the generated extracted information (e.g., the extracted video clip) and a message indicating the unauthorized action type on the second display unit 19 (ACT 63). The layout of the display in ACT 63 is similar to the layout shown in FIG. 10. The display unit 102 may repeatedly display the extracted information for a predetermined time on the second display unit 19.

Displaying such extracted information on the second display unit 19 promotes the prevention of an unauthorized action by the customer. Also, displaying the message 193 indicating that an unauthorized action was carried out along with the extracted information on the second display unit 19, enhances the deterrence effects against unauthorized actions by the customer.

Next, the control unit 100 determines whether the unauthorized action notice is canceled or not (ACT 35). The control unit 100 waits until the cancelation of the unauthorized action notice is carried out (NO in ACT 35). If the unauthorized action is canceled (YES in ACT 35), the control unit 100 erases the extracted information and the message displayed on the second display unit 19 (ACT 64).

Next, the control unit 100 determines whether the unauthorized action detection processing has ended or not (ACT 37). If the unauthorized action detection processing is not ended (NO in ACT 37), the control unit 100 returns to ACT 31 and continues monitoring for an unauthorized action by the customer. If the unauthorized action detection processing is ended (YES in ACT 37), the control unit 100 ends the processing of the subroutine started in ACT 16.

If it is determined in ACT 31 that there is no unauthorized action (NO in ACT 31), the control unit 100 executes the processing of ACT 37 without executing the processing of ACTS 61 to 64.

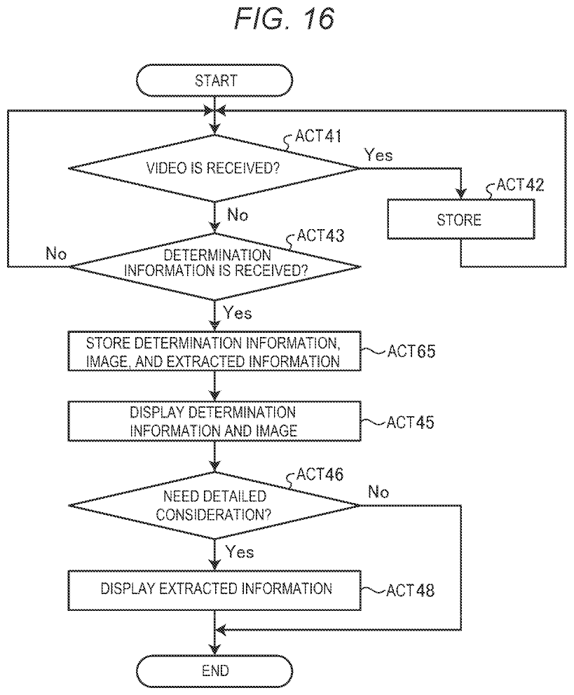

The control of the attendant PC 7 in the second embodiment will now be described. FIG. 16 is a flowchart of the control processing of the attendant PC 7 in the second embodiment. As shown in FIG. 16, in ACT 65, the control unit 700 stores the determination information and the unauthorized action image received from the self-service POS terminal 1 in the image memory unit 732 and stores the extracted information, similarly received, in the extracted information unit 733. In FIG. 16, the processing of ACT 47 (see FIG. 11) is not present and the extracted information stored in the extracted information unit 733 in ACT 65 is displayed in the processing of ACT 48.

As the self-service POS terminal 1 according to the second embodiment as described above, the self-service POS terminal 1 at which the customer himself or herself carries out an operation has the second display unit 19, the acquisition unit 101 acquiring a video of the operation by the customer from the camera 24, and the display unit 102 displaying a video including an unauthorized action extracted from the acquired video, on the second display unit 19.

In such a self-service POS terminal 1, if it is determined that there is an unauthorized action by the customer, a video clip including the unauthorized action is extracted from the video from the camera 24 and is displayed on the second display unit 19. Therefore, an unauthorized action by the customer can be prevented.

Various modifications are possible. For example, in one embodiment, a self-service POS terminal 1 houses or provides the unauthorized operation unit 143. However, in other examples, the store server 3 or another server may house or provide the unauthorized operation unit 143. In such a case, the self-service POS terminal 1 acquires the information about unauthorized actions stored in the unauthorized operation unit 143 from a server for determining whether there is an unauthorized action or not.

In an embodiment, the picked-up video of the operation by the customer is displayed on the second display unit 19, which is a different display unit from the first display unit 18. However, in other examples, the picked-up video of the operation by the customer and a message indicating an unauthorized action may be displayed on the first display unit 18. In this case, the second display unit 19 may no longer be required.

In an embodiment, a self-service POS device at which the customer performs both the registration operation and the payment operation is described as an example of the self-service POS terminal 1. However, this is not limiting. A semi-self-service POS payment system in which the salesclerk or the like performs the registration operation and then the customer uses a semi-self-service POS payment device to performs a payment operation may be used. In such a case, the semi-self-service POS payment device serves as the self-service POS terminal 1.

In an embodiment, whether there is an unauthorized action by the customer or not is determined, using a skeleton estimation technique. However, determination of whether there is an unauthorized action or not may be determined using other techniques alone or in combination with a skeleton estimation technique.

A program executed by the self-service POS terminal 1 according to the embodiments may be provided in the form of a file recorded in an installable format or an executable format on a computer-readable recording medium such as a CD-ROM, a flexible disk (FD), a CD-R, or a DVD (digital versatile disk).

A program executed by the self-service POS terminal 1 according to an embodiment may be stored in a computer connected to a network such as the internet and downloaded and/or accessed via the network. A program executed by a self-service POS terminal 1 according to an embodiment may also be configured to be provided or distributed via a network such as the internet.

The program executed by a self-service POS terminal 1 according to an embodiments may also be incorporated in ROM or the like and thus provided.

While some embodiments of the present disclosure have been described, these embodiments are presented simply as examples and are not intended to limit the scope of the present disclosure. These embodiments can be implemented in various other forms and can include various omissions, replacements, changes, and combinations without departing from the spirit and scope of the present disclosure. These embodiments and the modifications thereof are included in the spirit and scope of the present disclosure and also included in the scope of the claims and equivalents thereof.

What is claimed is:

1. A self-service point-of-sale terminal, comprising:
a control unit configured to register an item in a sales transaction;
a first display unit facing a customer operating the terminal in the sales transaction;
a second display unit facing the customer operating the terminal in the sales transaction; and
a peripheral interface connected to the control unit and configured to receive video of the customer operating the terminal from a camera, wherein
the control unit is configured to:
cause the first display unit to display information about the registered item, and
cause the second display unit to display at least a part of the video received by the peripheral interface.

2. The self-service point-of-sale terminal according to claim 1, wherein the control unit causes the second display unit to display all of the video received by the peripheral interface in real time.

3. The self-service point-of-sale terminal according to claim 1, wherein the control unit is further configured to:
identify an unauthorized action by the customer operating the terminal based on analysis of the received video, and
cause a video clip corresponding to a time of the identified unauthorized action to be extracted from the received video.

4. The self-service point-of-sale terminal according to claim 3, wherein the control unit is further configured to:
cause the video clip to be displayed on at least one of the first and second display units.

5. The self-service point-of-sale terminal according to claim 1, wherein the control unit is further configured to:
identify an unauthorized action by the customer operating the terminal based on analysis of the received video, and
cause a message to be displayed on at least one of the first and second display units, the message indicating the unauthorized action has been identified.

6. The self-service point-of-sale terminal according to claim 1, wherein the control unit is further configured to:
identify an unauthorized action by the customer operating the terminal based on analysis of the received video, and
cause a notification to be transmitted to an attendant terminal, the notification indicating the unauthorized action has been identified.

7. The self-service point-of-sale terminal according to claim 6, wherein
the control unit is further configured to:
cause a video clip corresponding to a time of the identified unauthorized action to be extracted from the received video, and
the video clip is transmitted with the notification to the attendant terminal.

8. The self-service point-of-sale terminal according to claim 7, wherein the control unit is further configured to:
cause the video clip to be displayed on at least one of the first and second display units.

9. The self-service point-of-sale terminal according to claim 1, wherein the first and second display units are separate display screens.

10. The self-service point-of-sale terminal according to claim 1, wherein the control unit is further configured to:
identify an unauthorized action by the customer operating the terminal based on analysis of the received video in conjunction with operating event information related to the operation of the terminal by the customer.

11. The self-service point-of-sale terminal according to claim 10, wherein the control unit performs skeleton analysis on the received video and compares skeletal movements obtained by the skeleton analysis to stored skeletal movements for known unauthorized action types.

12. A method for a self-service point-of-sale terminal, the method comprising:
receiving video from a camera, the video including images of a customer operating the terminal in a sales transaction;
causing a first display unit of the terminal to display information about a registered item in the sales transaction; and
causing a second display unit of the terminal to display at least a part of the received video.

13. The method according to claim 12, wherein the second display unit displays all of the received in real time.

14. The method according to claim 12, further comprising:
identifying an unauthorized action by the customer operating the terminal based on analysis of the received video; and
causing a video clip corresponding to a time of the identified unauthorized action to be extracted from the received video.

15. The method according to claim 14, further comprising:
causing the video clip to be displayed on at least one of the first and second display units.

16. The method according to claim 12, further comprising:
identifying an unauthorized action by the customer operating the terminal based on analysis of the received video; and
causing a message to be displayed on at least one of the first and second display units, the message indicating the unauthorized action has been identified.

17. The method according to claim 12, further comprising:
identifying an unauthorized action by the customer operating the terminal based on analysis of the received video; and
causing a notification to be transmitted to an attendant terminal, the notification indicating the unauthorized action has been identified.

18. The method according to claim 17, further comprising:
causing a video clip corresponding to a time of the identified unauthorized action to be extracted from the received video, wherein
the video clip is transmitted with the notification to the attendant terminal.

19. The method according to claim 18, further comprising:
causing the video clip to be displayed on at least one of the first and second display units.

20. The method according to claim 12, wherein the first and second display units are separate display screens.
